(19) United States
(12) Patent Application Publication
(10) Pub. No.: US 2026/0281364 A1
(43) Pub. Date: Sep. 17, 2026

(54) HARDWARE FOR DECODER-SIDE INTRA MODE DERIVATION AND PREDICTION

(71) Applicant: MEDIATEK INC., Hsinchu City (TW)

(72) Inventors: Hong-Hui CHEN, Hsinchu City (TW); Chia-Ming TSAI, Hsinchu City (TW); Chih-Wei HSU, Hsinchu City (TW)

(21) Appl. No.: 18/871,949

(22) PCT Filed: May 29, 2023
(86) PCT No.: PCT/CN2023/096737

§ 371 Date: Dec. 5, 2024

Related U.S. Application Data
(60) Provisional application No. 63/351,505, filed on Jun. 13, 2022.

(51) Int. Cl. H04N 19/136; H04N 19/159; H04N 19/176

(52) U.S. Cl. CPC H04N 19/136; H04N 19/159; H04N 19/176

(57) ABSTRACT

A method for performing decoder-side intra mode derivation (DIMD) that reduces hardware cost is provided. A video coder receives data for a block of pixels to be encoded or decoded as a current block of a current picture of a video. The video coder derives a histogram of gradients (HoG) having a plurality of bins corresponding to different intra prediction angles. A value for an accumulated gradient amplitude of each bin is stored and the value is constrained by a particular bit-width. Each bin stores a value for an accumulated gradient amplitude that is constrained by a particular bit-width. The video coder identifies two or more intra prediction modes based on the HoG. The video coder generates an intra-prediction of the current block based on the identified two or more intra prediction modes. The video coder encodes or decodes the current block by using the generated intra-prediction.

### CROSS REFERENCE TO RELATED PATENT APPLICATION(S)

The present disclosure is part of a non-provisional application that claims the priority benefit of U.S. Provisional Patent Application No. 63/351,505, filed on 13 Jun. 2022. Content of above-listed application is herein incorporated by reference.

### TECHNICAL FIELD

The present disclosure relates generally to video coding. In particular, the present disclosure relates to hardware supporting decoder-side intra mode derivation and prediction (DIMD).

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUS).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide methods for performing decoder-side intra mode derivation (DIMD) at reduced hardware cost. A video coder receives data for a block of pixels to be encoded or decoded as a current block of a current picture of a video. The video coder derives a histogram of gradients (HoG) having a plurality of bins corresponding to different intra prediction angles. A value for an accumulated gradient amplitude of each bin is stored and the value is constrained by a particular bit-width. The video coder identifies two or more intra prediction modes based on the HoG. The video coder generates an intra-prediction of the current block based on the identified two or more intra prediction modes. The video coder encodes or decodes the current block by using the generated intra-prediction.

In some embodiments, the stored accumulated gradient amplitude is clamped to be less than a particular value based on the particular bit-width. In some embodiments, the particular bit-width is 18 bits. In some embodiments, the particular bit-width can be 12, 13, 14, 15, 16, 17, 18, 19, or 20 bits.

In some embodiments, the two or more intra prediction modes are identified from the plurality of bins of the HoG by a comparator structure having one or more N-in-M-out comparator elements. Each N-in-M-out element selects M largest values from N values, M and N are integers, N>M≥2. Each input to the N-in-M-out comparator element includes the value stored in a bin of the HoG and an index assigned to the bin. The index is appended to the value as the least significant part of the input, and the index may be bit-wise inverted. In some embodiments, at least an input or at least an output of the N-in-M-out comparator element is constrained by the particular bit-width.

In some embodiments, the two or more intra prediction modes are identified from the plurality of bins of the HoG by two or more comparison trees, each of the comparison tree identifying a different intra prediction mode. A first comparison tree identifies a first intra prediction mode from HoG bins with odd-numbered indices and a second comparison trees identifies a second intra prediction mode from HoG bins with even-numbered indices.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows the intra-prediction modes in different directions.

FIGS. 2A-2B conceptually illustrate top and left reference templates with extended lengths for supporting wide-angular direction mode for non-square blocks of different aspect ratios.

FIG. 3 illustrates using decoder-side intra mode derivation (DIMD) to implicitly derive an intra prediction for a current block.

FIG. 4 conceptually illustrates applying comparison trees to odd and even HoG bin indices separately to identify DIMD intra modes.

FIGS. 5A-5B illustrate a cascaded structures of 3-in-2-out elements configured for DIMD intra mode generation.

FIG. 6 illustrates an example video encoder that may implement DIMD.

FIG. 7 illustrates portions of the video encoder that implement DIMD based on reduced bit-widths.

FIG. 8 conceptually illustrates a process that performs DIMD with reduced bit-widths.

FIG. 9 illustrates an example video decoder 900 that may implement DIMD.

FIG. 10 illustrates portions of the video decoder 900 that implement DIMD based on reduced bit-widths.

FIG. 11 conceptually illustrates a process 1100 that performs DIMD with reduced bit-widths.

FIG. 12 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Intra Prediction Modes

Intra-prediction method exploits one reference tier adjacent to the current prediction unit (PU) and one of the intra-prediction modes to generate the predictors for the current PU. The Intra-prediction direction can be chosen among a mode set containing multiple prediction directions. For each PU coded by Intra-prediction, one index will be used and encoded to select one of the intra-prediction modes. The corresponding prediction will be generated and then the residuals can be derived and transformed.

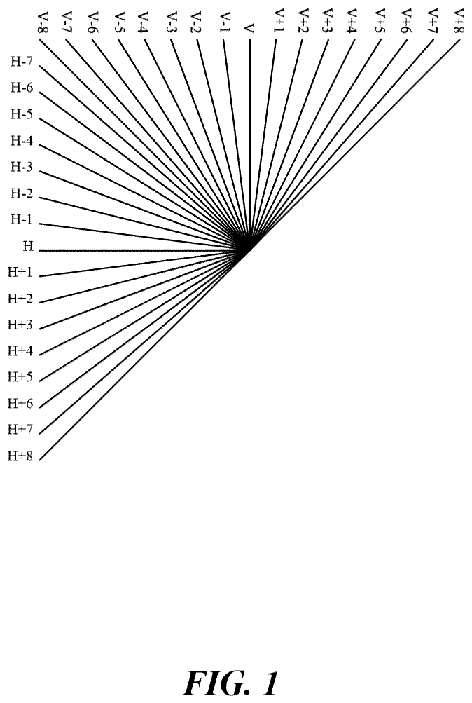

FIG. 1 shows the intra-prediction modes in different directions. These intra-prediction modes are referred to as directional modes and do not include DC mode or Planar mode. As illustrated, there are 33 directional modes (V: vertical direction; H: horizontal direction), so H, H+1~H+8, H−1~H−7, V, V+1~V+8, V−1~V−8 are used. Generally directional modes can be represented as either as H+k or V+k modes, where k=+1, +2, . . . , +8. Each of such intra-prediction mode can also be referred to as an intra-prediction angle. To capture arbitrary edge directions presented in natural video, the number of directional intra modes may be extended from 33, as used in HEVC, to 65 direction modes so that the range of k is from ±1 to ±16. These denser directional intra prediction modes apply for all block sizes and for both luma and chroma intra predictions. By including DC and Planar modes, the number of intra-prediction mode is 35 (or 67).

Out of the 35 (or 67) intra-prediction modes, some modes (e.g., 3 or 5) are identified as a set of most probable modes (MPM) for intra-prediction in current prediction block. The encoder may reduce bit rate by signaling an index to select one of the MPMs instead of an index to select one of the 35 (or 67) intra-prediction modes. For example, the intra-prediction mode used in the left prediction block and the intra-prediction mode used in the above prediction block are used as MPMs. When the intra-prediction modes in two neighboring blocks use the same intra-prediction mode, the intra-prediction mode can be used as an MPM. When only one of the two neighboring blocks is available and coded in directional mode, the two neighboring directions immediately next to this directional mode can be used as MPMs. DC mode and Planar mode are also considered as MPMs to fill the available spots in the MPM set, especially if the above or top neighboring blocks are not available or not coded in intra-prediction, or if the intra-prediction modes in neighboring blocks are not directional modes. If the intra-prediction mode for current prediction block is one of the modes in the MPM set, 1 or 2 bits are used to signal which one it is. Otherwise, the intra-prediction mode of the current block is not the same as any entry in the MPM set, and the current block will be coded as a non-MPM mode. There are all-together 32 such non-MPM modes and a (5-bit) fixed length coding method is applied to signal this mode.

The MPM list is constructed based on intra modes of the left and above neighboring block. Suppose the mode of the left neighboring block is denoted as Left and the mode of the above neighboring block is denoted as Above, and the unified MPM list may be constructed as follows:
When a neighboring block is not available, its intra mode is set to Planar by default.
If both modes Left and Above are non-angular modes:
   MPM list→ {Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, Max+2}
If Left and Above are both angular and they are different:
   Set a mode Max as the larger mode in Left and Above.
   Set a mode Min as the smaller mode in Left and Above
   If Max−Min is equal to 1:
      MPM list→{Planar, Left, Above, Min−1, Max+1, Min−2}
   Otherwise, if Max-Min is greater than or equal to 62:
      MPM list→{Planar, Left, Above, Min+1, Max−1, Min+2}
   Otherwise, if Max−Min is equal to 2:
      MPM list→{Planar, Left, Above, Min+1, Min−1, Max+1}
   Otherwise:
      MPM list→{Planar, Left, Above, Min−1, Min+1, Max−1}
If Left and Above are both angular and they are the same:
   MPM list→{Planar, Left, Left−1, Left+1, Left−2, Left+2}

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indices, which are remapped to indices of wide angular modes after parsing.

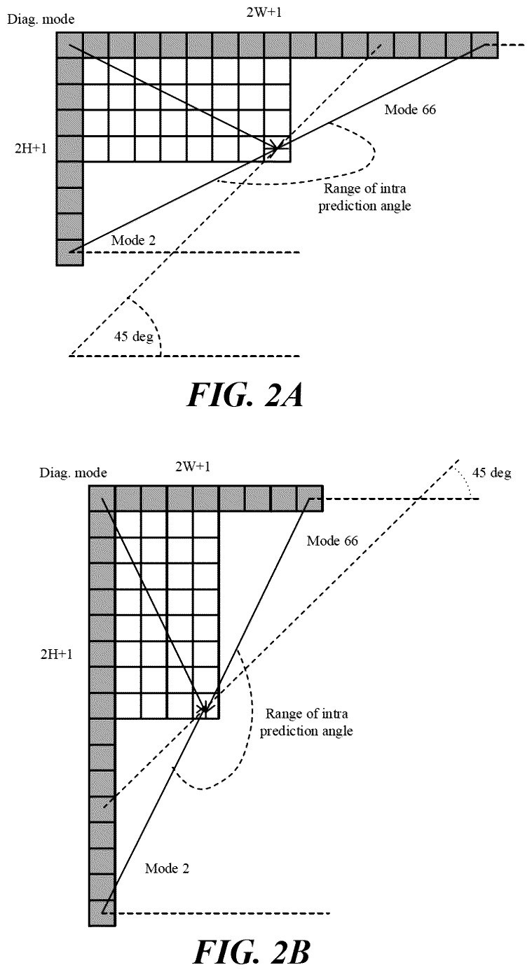

For some embodiments, the total number of intra prediction modes is unchanged, i.e., 67, and the intra mode coding method is unchanged. To support these prediction directions, a top reference template with length 2 W+1 and a left reference template with length 2H+1 are defined. FIGS. 2A-B conceptually illustrate top and left reference templates with extended lengths for supporting wide-angular direction mode for non-square blocks of different aspect ratios.

The number of replaced modes in wide-angular direction mode depends on the aspect ratio of a block. The replaced intra prediction modes for different blocks of different aspect ratios are shown in Table 1 below.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Modes 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, |
| | 65, 66 |

### II. Decoder Side Intra Mode Derivation (DIMD)

Decoder-Side Intra Mode Derivation (DIMD) is a technique in which two intra prediction modes/angles/directions are derived from the reconstructed neighbor samples (template) of a block, and those two predictors are combined with the planar mode predictor with the weights derived from the gradients. The DIMD mode is used as an alternative prediction mode and is always checked in high-complexity RDO mode. To implicitly derive the intra prediction modes of a blocks, a texture gradient analysis is performed at both encoder and decoder sides. This process starts with an empty Histogram of Gradient (HoG) having 65 entries (also called bins), corresponding to the 65 angular/directional intra prediction modes. Accumulated gradient amplitudes (also called bin values) of these entries are determined during the texture gradient analysis.

A video coder performing DIMD performs the following steps: in a first step, the video coder picks a template of T=3 columns and lines from respectively left and above current block. This area is used as the reference for the gradient based intra prediction modes derivation. In a second step, the horizontal and vertical Sobel filters are applied on all 3×3 window positions, centered on the pixels of the middle line of the template. On each window position, Sobel filters calculate the intensity of pure horizontal and vertical directions as Gₓ and G_{y}, respectively. Then, the texture angle of the window is calculated as:

$$angle = arctan ( {G}_{x} / {G}_{y} ) ,$$

which can be converted into one of the 65 angular intra prediction modes. Once the intra prediction modes index of current window is derived as idx, the amplitude of its entry in the HoG[idx] is updated by addition according to:

$$ampl = \vert {G}_{x} \vert + \vert {G}_{y} \vert .$$

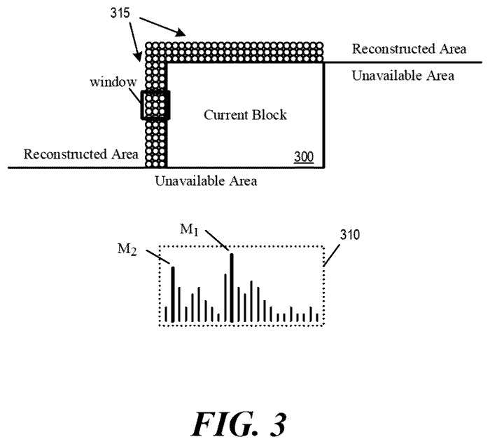

FIG. 3 illustrates using decoder-side intra mode derivation (DIMD) to implicitly derive an intra prediction for a current block. The figure shows an example Histogram of Gradient (HoG) 310 that is calculated after applying the above operations on all pixel positions in a template 315 that includes neighboring lines of pixel samples around a current block 300. Once the HoG is computed, the indices of the bins with the two tallest histogram bars (M₁ and M₂) are selected as the two implicitly derived intra prediction modes (IPMs or DIMD intra modes) for the block. The prediction of the two IPMs are further combined with the planar mode as the prediction of DIMD mode. The prediction fusion is applied as a weighted average of the above three predictors (M₁ prediction, M₂ prediction, and planar mode prediction). To this aim, the weight of planar may be set to 21/64 (~⅓). The remaining weight of 43/64 (~⅔) is then shared between the two HoG IPMs, proportionally to the amplitude of their HoG bars. The prediction fusion or combined prediction for DIMD can be:

$${Pred}_{DIMD} = ( 43 * ( w 1 * {pred}_{M 1} + w 2 * {pred}_{M 2} ) + 21 * {pred}_{planar} ) ≫ 6$$

$$w 1 = {amp}_{M 1} / ( {amp}_{M 1} + {amp}_{M 2} )$$

$$w 2 = {amp}_{M 2} / ( {amp}_{M 1} + {amp}_{M 2} )$$

In addition, the two implicitly derived intra prediction modes are added into the most probable modes (MPM) list, so the DIMD process is performed before the MPM list is constructed. The primary derived intra mode of a DIMD block is stored with a block and is used for MPM list construction of the neighboring blocks.

More generally, the DIMD process may be used to produced K IPMs or DIMD intra modes, wherein K≥2. The K IPMs are identified based on K bins having the K highest gradient amplitude accumulations in the HoG. The K IPMs are then used in a weighted sum to generate the DIMD intra prediction PredDIMD.

### III. Hardware for DIMD

Some embodiments of the disclosure provide structured DIMD hardware implementation with reduced hardware cost by constraining the maximal bit-width for representing HoG bin values or amplitudes. To generate the two DIMD intra modes (M₁ and M₂), a comparison process is used for extracting the indices of the two bins with the highest and second highest gradient accumulation values in the HoG. In some embodiments, the comparison process is used for extracting more than two indices (e.g., 5) of the bins having the highest gradient accumulation values.

In some embodiments, the video coder implements a sequential loop traversing all bins of the HoG and keeps updating the two (or more) indices for the two HoG bins with the highest and the second highest bin values (e.g., M₁ and M₂). In some embodiments, when the loop is traversing from the bin with the highest bin value to the bin with the second highest bin value while encountering a HoG bin with a new value that is equal to the highest or the second highest bin values, the video coder may disregard the index of this HoG bin. In some embodiments, if the new value is encountered when the loop is traversing from the bin with the second highest bin value (M₂) to the bin with the highest bin value (M₁), the index of the second highest bin value (M₂) is kept. On the other hand, if the new value is encountered when the loop is traversing from the bin with the highest bin value (M₁) to the bin with the second highest bin value (M₂), the index of the first highest bin value (M₁) is kept. However, this sequential loop is not easily adaptable to parallel computing flow nor hardware implementations.

Some embodiments of the disclosure provide a HoG bin comparison/selection architecture that is readily adaptable to parallel computing or hardware implementation. Specifically, two comparison trees are utilized to identify two candidate intra modes.

In some embodiments, the bins with even indices are fed to a first comparison tree to generate a first intra mode candidate, which is the index associated with the highest bin value from the first comparison tree. If two bin values are equal at a certain node of the comparison tree, the bin with the larger bin index (or with the smaller bin index) is kept (based on a selection policy that is predefined or signaled in the coded video at e.g., SPS header). The same process is applied to odd indices to obtain a second intra mode candidate based on a second comparison tree. The two intra mode candidates are then compared, and the one with higher bin value is the first DIMD intra mode (M₁) while the other is the second DIMD intra mode (M₂).

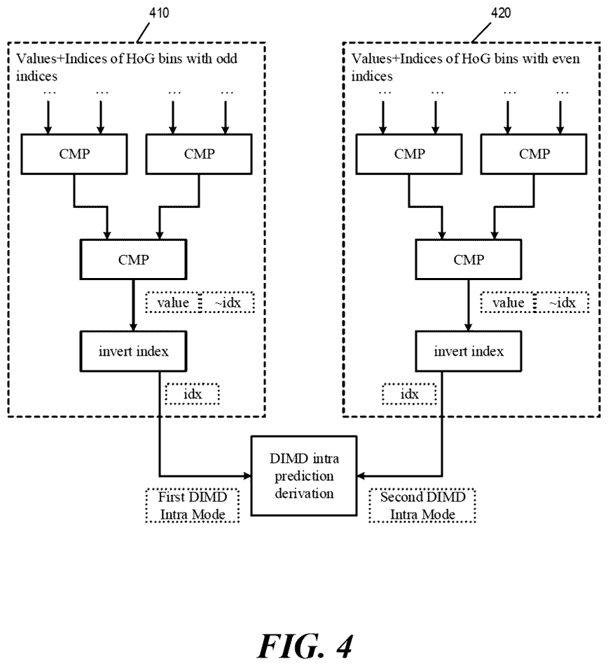

FIG. 4 conceptually illustrates applying comparison trees to odd and even HoG bin indices separately to identify DIMD intra modes. As illustrated, a first comparison tree 410 is used to identify the highest valued HoG bin among bins of odd indices, and a second comparison tree 420 is used to identify the highest valued HoG bin among bins of even indices. Each comparator (CMP) is a 2-in-1-out comparator that compares two data items corresponding to two bins, each data item of a bin includes the bin value (accumulated gradient amplitude) with the index of the bin appended to the LSB. The appended index serves as a tiebreaker during comparison with another bin data item having the same bin value. In some embodiments, the index in the data item is bit-wise inverted (~idx) so the tiebreaker favors the smaller index. The first comparison tree 410 outputs the index of the bin with the highest bin value among the odd-indexed bins, and the second comparison tree 420 outputs the index of the bin with the highest bin value among the even-indexed bins.

In some embodiments, instead of having a first comparison tree for odd-indexed bins and second comparison tree for even-indexed bins, the first comparison tree 410 may be applied to bins with indices greater than a threshold and the second comparison tree 420 may be applied to bins with indices less than or equal to the threshold. Other classification schemes for comparing and selecting the two DIMD intra modes are also possible. In some embodiment, more than two comparison trees are applied to more than two different subsets of HoG bins to identify more than two DIMD intra modes. In some embodiments, rather than using multiple comparison trees to identify multiple DIMD intra modes, one comparison tree is used multiple times on multiple different subsets of the HoG bins to identify multiple DIMD intra modes.

The separation of even and odd indices as described by reference to FIG. 4 is parallelism and hardware friendly. However, this method may generate DIMD intra modes that are different than those generated by the single sequential loop search.

In some embodiments, to identify DIMD intra modes that are the same as those generated by the single sequential loop search of the HoG, N-in-M-out comparator elements are cascaded to identify M DIMD intra modes from all possible HoG bins. Each N-in-M-out element is configured to identify and output M largest values from among the N input values. Thus, for example, in some embodiments, to identify 2 DIMD intra modes out of all possible HoG bins, a cascaded structure (or comparator tree) of 3-in-2-out elements (also called I3M2 elements) may be used.

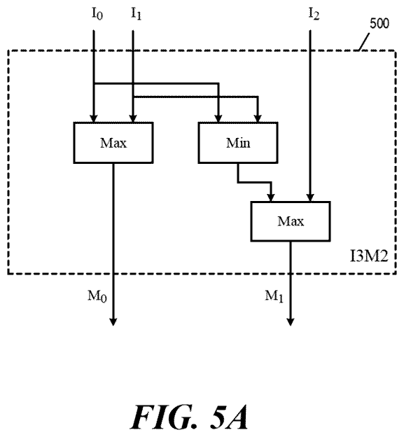

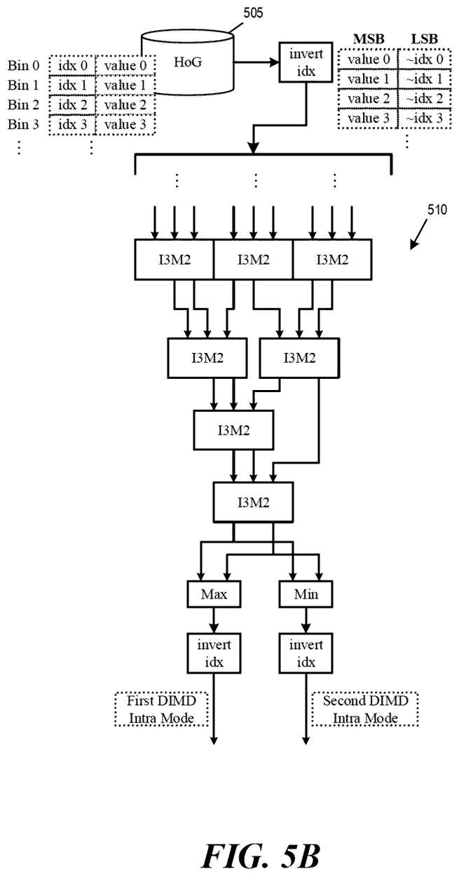

FIGS. 5A-B illustrate a cascaded structures of 3-in-2-out elements configured for DIMD intra mode generation. The cascaded structure can be utilized to generate DIMD intra modes identical to those from the sequential loop search.

FIG. 5A shows the implementation details of an I3M2 element 500 where simple two-input Max and Min operations are performed. A “Min” operation is one that selects the smaller of the two input items being compared. A “Max” operation is one that selects the larger of the two input items being compared. The I3M2 element receives three input items (I₀, I₁, I₂) and outputs the two largest input items (M₀, M₁). The smallest input item is discarded.

FIG. 5B shows a cascade structure 510 of I3M₂s that is used to generate/identify two final outputs as DIMD intra modes. The inputs to the cascaded structure 510 are data items that correspond to the bins of a DIMD HoG 505. Each data item includes an accumulated gradient amplitude value of a HoG bin that is appended with the bin's index at the LSB (lease significant bits). The appended index of the bin serves as a tiebreaker when the bin is being compared by an I3M2 with another bin having an equal gradient amplitude value. The index is bitwise inverted such that when two bins have equal values (in their respective MSBs), the bin with the smaller index would win the tiebreaker. In some other embodiments, the index is not inverted so that the tiebreaker is in favor of the bin with the larger index.

The two final outputs of the structure 510 correspond to the two inputs to this structure having the first highest and the second highest input values. The two highest bin values and their corresponding indices are extracted from these two final outputs. The indices are bit-wise inverted back. Upon comparison of the two extracted bin values, the index of the bin with the larger bin value is designated as the first DIMD intra mode and the index with the smaller bin value is designated as the second DIMD intra mode.

DIMD HoG bins accumulate the gradient values for different gradient directions. The maximal bit precision required for accumulating the gradient values may be bounded according to the maximal CU size whose gradient values of the position around the L shape is the maximal gradient value based on the filter coefficients. However, this maximal bit precision imposes a certain hardware cost.

In some embodiments, to reduce the hardware cost, the precision for the amplitudes of the accumulated gradient values is limited to a specific bit-width. In some embodiments, the precision for each HoG bin is set to be W bits, and after a new gradient value is added to a certain bin, the result is clamped to a maximal value equal to 2^{W}−1 before being stored back to the HoG storage for that bin. For some embodiments in which N-in-M-out comparator elements (e.g., I3M2) are cascaded as a comparator structure (e.g., comparator structure 510) to identify M (e.g., 2, 5, etc.) DIMD intra modes, the bit-widths of comparator's inputs and outputs (e.g., I₀, I₁, I₂, M₀, M₁) are limited to W.

By properly choosing the W value, the coding gain of the DIMD process can be preserved even with a reduced storage cost of the HoG bin values. For some embodiments, it is empirically determined that reducing the bit-width to W=18 would not negatively affect the performance of coded video. Thus, for some embodiments, the bit-width of DIMD gradient amplitude accumulation is limited to W=18 bits, though W=16, 17, 19, or 20 may also be used as the bit-width of gradient amplitude accumulation.

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

### IV. Example Video Encoder

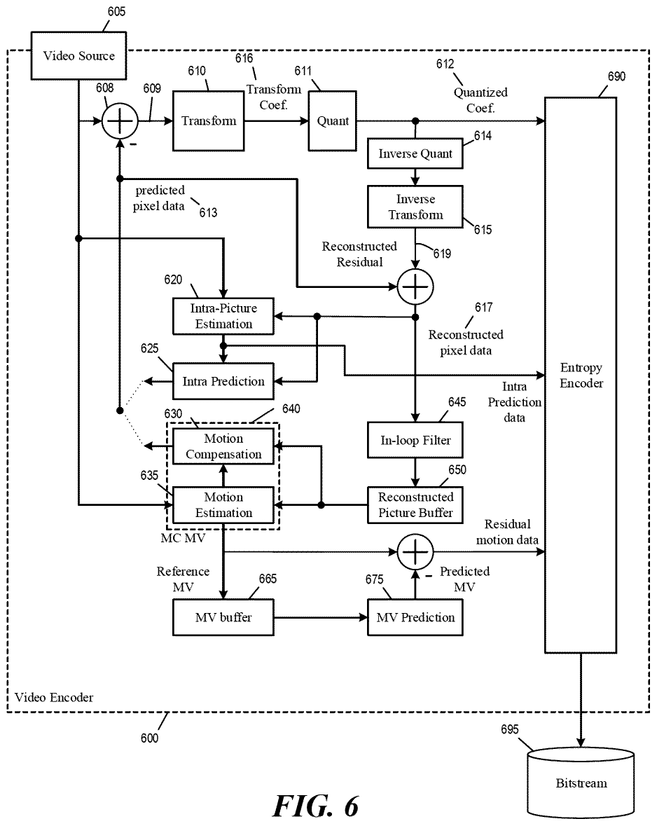

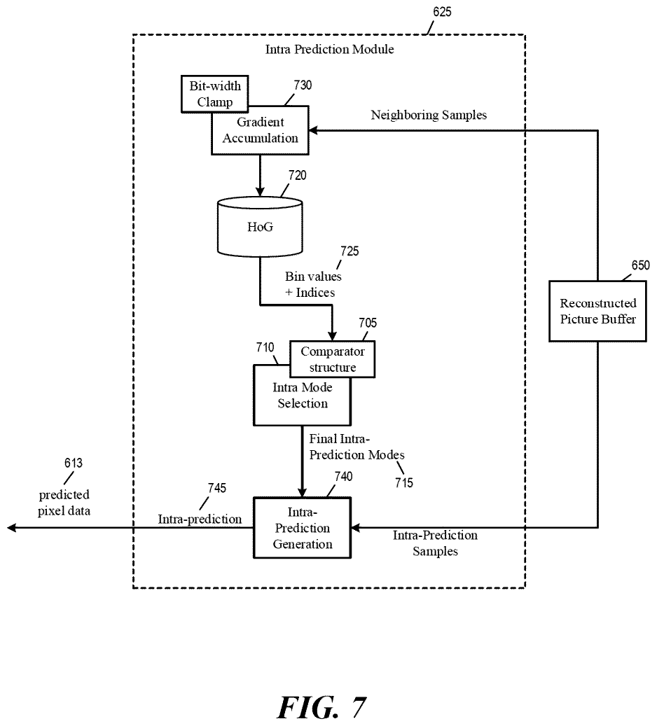

FIG. 6 illustrates an example video encoder 600 that may implement decoder-side intra mode derivation (DIMD). As illustrated, the video encoder 600 receives input video signal from a video source 605 and encodes the signal into bitstream 695. The video encoder 600 has several components or modules for encoding the signal from the video source 605, at least including some components selected from a transform module 610, a quantization module 611, an inverse quantization module 614, an inverse transform module 615, an intra-picture estimation module 620, an intra-prediction module 625, a motion compensation module 630, a motion estimation module 635, an in-loop filter 645, a reconstructed picture buffer 650, a MV buffer 665, and a MV prediction module 675, and an entropy encoder 690. The motion compensation module 630 and the motion estimation module 635 are part of an inter-prediction module 640.

In some embodiments, the modules 610-690 are modules of software instructions being executed by one or more processing units (e.g., a processor) of a computing device or electronic apparatus. In some embodiments, the modules 610-690 are modules of hardware circuits implemented by one or more integrated circuits (ICs) of an electronic apparatus. Though the modules 610-690 are illustrated as being separate modules, some of the modules can be combined into a single module.

The video source 605 provides a raw video signal that presents pixel data of each video frame without compression. A subtractor 608 computes the difference between the raw video pixel data of the video source 605 and the predicted pixel data 613 from the motion compensation module 630 or intra-prediction module 625 as prediction residual 609. The transform module 610 converts the difference (or the residual pixel data or residual signal 608) into transform coefficients (e.g., by performing Discrete Cosine Transform, or DCT). The quantization module 611 quantizes the transform coefficients into quantized data (or quantized coefficients) 612, which is encoded into the bitstream 695 by the entropy encoder 690.

The inverse quantization module 614 de-quantizes the quantized data (or quantized coefficients) 612 to obtain transform coefficients, and the inverse transform module 615 performs inverse transform on the transform coefficients to produce reconstructed residual 619. The reconstructed residual 619 is added with the predicted pixel data 613 to produce reconstructed pixel data 617. In some embodiments, the reconstructed pixel data 617 is temporarily stored in a line buffer (not illustrated) for intra-picture prediction and spatial MV prediction. The reconstructed pixels are filtered by the in-loop filter 645 and stored in the reconstructed picture buffer 650. In some embodiments, the reconstructed picture buffer 650 is a storage external to the video encoder 600. In some embodiments, the reconstructed picture buffer 650 is a storage internal to the video encoder 600.

The intra-picture estimation module 620 performs intra-prediction based on the reconstructed pixel data 617 to produce intra prediction data. The intra-prediction data is provided to the entropy encoder 690 to be encoded into bitstream 695. The intra-prediction data is also used by the intra-prediction module 625 to produce the predicted pixel data 613.

The motion estimation module 635 performs inter-prediction by producing MVs to reference pixel data of previously decoded frames stored in the reconstructed picture buffer 650. These MVs are provided to the motion compensation module 630 to produce predicted pixel data.

Instead of encoding the complete actual MVs in the bitstream, the video encoder 600 uses MV prediction to generate predicted MVs, and the difference between the MVs used for motion compensation and the predicted MVs is encoded as residual motion data and stored in the bitstream 695.

The MV prediction module 675 generates the predicted MVs based on reference MVs that were generated for encoding previously video frames, i.e., the motion compensation MVs that were used to perform motion compensation. The MV prediction module 675 retrieves reference MVs from previous video frames from the MV buffer 665. The video encoder 600 stores the MVs generated for the current video frame in the MV buffer 665 as reference MVs for generating predicted MVs.

The MV prediction module 675 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 695 by the entropy encoder 690.

The entropy encoder 690 encodes various parameters and data into the bitstream 695 by using entropy-coding techniques such as context-adaptive binary arithmetic coding (CABAC) or Huffman encoding. The entropy encoder 690 encodes various header elements, flags, along with the quantized transform coefficients 612, and the residual motion data as syntax elements into the bitstream 695. The bitstream 695 is in turn stored in a storage device or transmitted to a decoder over a communications medium such as a network.

The in-loop filter 645 performs filtering or smoothing operations on the reconstructed pixel data 617 to reduce the artifacts of coding, particularly at boundaries of pixel blocks. In some embodiments, the filtering or smoothing operations performed by the in-loop filter 645 include deblock filter (DBF), sample adaptive offset (SAO), and/or adaptive loop filter (ALF).

FIG. 7 illustrates portions of the video encoder 600 that implement DIMD based on reduced bit-widths. Specifically, the figure illustrates the components of the intra-prediction module 625 of the video encoder 600. As illustrated, the intra-prediction module 625 includes a gradient accumulation module 730, a HoG storage 720, an intra mode selection module 710, and an intra-prediction generation module 740. The intra-prediction module 625 may use these modules to perform DIMD intra-prediction for both luma and chroma components.

The gradient accumulation module 730 receives neighboring samples of the current block from the reconstructed picture buffer 650 and computes gradient amplitudes for different intra mode directions. The accumulated gradient amplitude of each HoG bin is limited (e.g., clamped) to a maximum allowed value 2^{W}−1 based on a predetermined bit-width W. The (clamped) accumulated gradient amplitudes are stored in the HoG storage 720 as values in different bins that correspond to the different intra mode directions.

The intra mode selection module 710 examines the different bins stored in the HoG storage 720 to identify the two (or more) final DIMD intra modes 715. The intra mode selection module 710 includes a comparator tree 705 that compares bin data items 725 from different HoG bins to identify the two or more bins having the highest accumulated gradient amplitudes. In some embodiments, each bin data item includes the bin value at the MSB and the bin index at the LSB. In some of these embodiments, the bin index in each data item is bit-wise inverted.

In some embodiments, the comparator structure 705 includes one comparator trees that is used to identify the two (or more) bins with the highest accumulated bin values from all HoG bins. The comparator tree is a cascaded structure of N-in-M-out comparator elements (e.g., I3M2 elements) (e.g., cascaded structure 510).

In some embodiments, the comparator structure 705 includes two (or more) comparator trees that are used to identify the two (or more) bins with the highest accumulated bin values. Each comparator tree is used to identify one bin from a different subset (e.g., odd vs. even) of the HoG bins. Each of the two or more comparator trees is a cascaded structure constructed from 2-in-1-out comparator elements (CMPs) (e.g., comparator trees 410 and 420).

The intra-prediction generation module 740 uses the final intra prediction mode(s) 715 to generate an intra-prediction 745 for the current block. The final prediction mode(s) 715 may include two or more DIMD intra modes, and the intra-prediction generation module 740 may fetch multiple predictions/predictors from the reconstructed picture buffer 650 based on the multiple DIMD intra modes. The fetched multiple predictors are blended to generate the intra-prediction 745 to be used as the predicted pixel data 613.

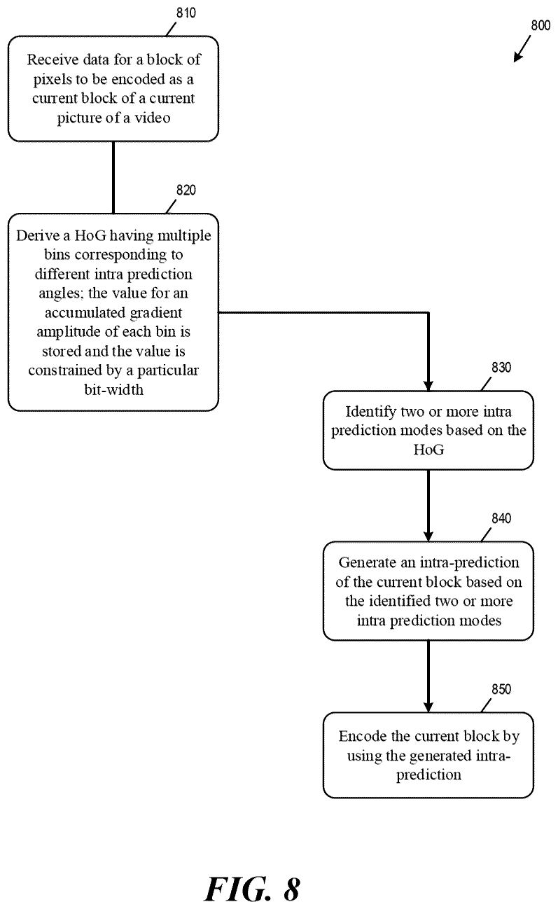

FIG. 8 conceptually illustrates a process 800 that performs DIMD with reduced bit-widths. In some embodiments, one or more processing units (e.g., a processor) of a computing device implementing the encoder 600 performs the process 800 by executing instructions stored in a computer readable medium. In some embodiments, an electronic apparatus implementing the encoder 600 performs the process 800.

The encoder receives (at block 810) data to be encoded as a current block of pixels in a current picture in a video.

The encoder derives (at block 820) a histogram of gradients (HoG) having a plurality of bins that correspond to different intra prediction angles. A value for an accumulated gradient amplitude of each bin is stored and the value is constrained by a particular bit-width. In some embodiments, the stored accumulated gradient amplitude is clamped to be less than a particular value based on the particular bit-width. In some embodiments, the particular bit-width is 18 bits. In some embodiments, the particular bit-width can be 12, 13, 14, 15, 16, 17, 18, 19, or 20 bits.

The encoder identifies (at block 830) two or more intra prediction modes based on the HoG. In some embodiments, the two or more intra prediction modes are identified from the plurality of bins of the HoG by a comparator structure having one or more N-in-M-out comparator elements. Each N-in-M-out element selects M largest values from N values, M and N are integers, N>M≥ 2. Each input to the N-in-M-out comparator element includes the value stored in a bin of the HoG and an index assigned to the bin. The index is appended to the value as the least significant part of the input, and the index may be bit-wise inverted. In some embodiments, at least an input or at least an output of the N-in-M-out comparator element is constrained by the particular bit-width.

In some embodiments, the two or more intra prediction modes are identified from the plurality of bins of the HoG by two or more comparison trees, each of the comparison tree identifying a different intra prediction mode. A first comparison tree identifies a first intra prediction mode from HoG bins with odd-numbered indices and a second comparison trees identifies a second intra prediction mode from HoG bins with even-numbered indices.

The encoder generates (at block 840) an intra-prediction of the current block based on the identified two or more intra prediction modes. The encoder encodes (at block 850) the current block by using the generated intra-prediction to produce prediction residuals.

### V. Example Video Decoder

In some embodiments, an encoder may signal (or generate) one or more syntax element in a bitstream, such that a decoder may parse said one or more syntax element from the bitstream.

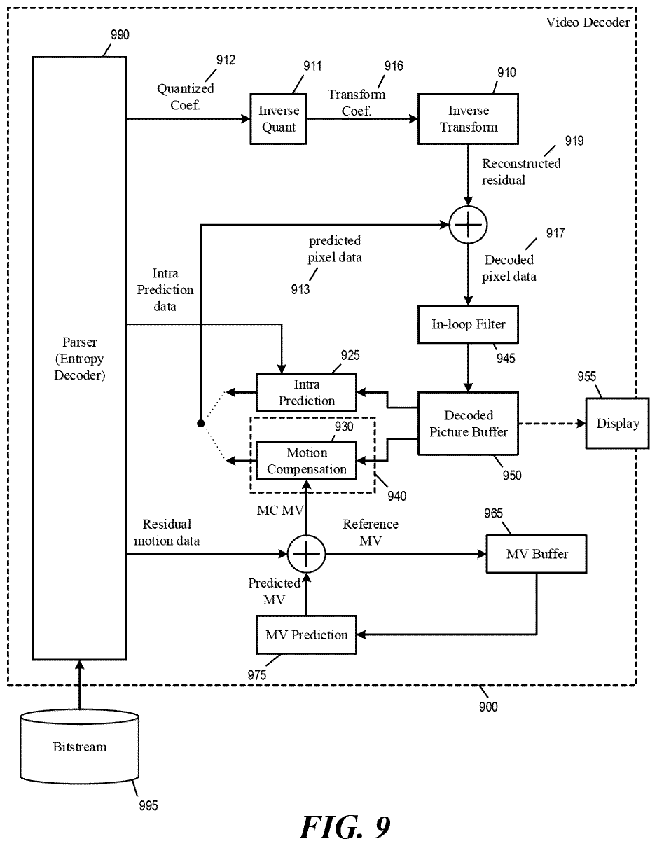

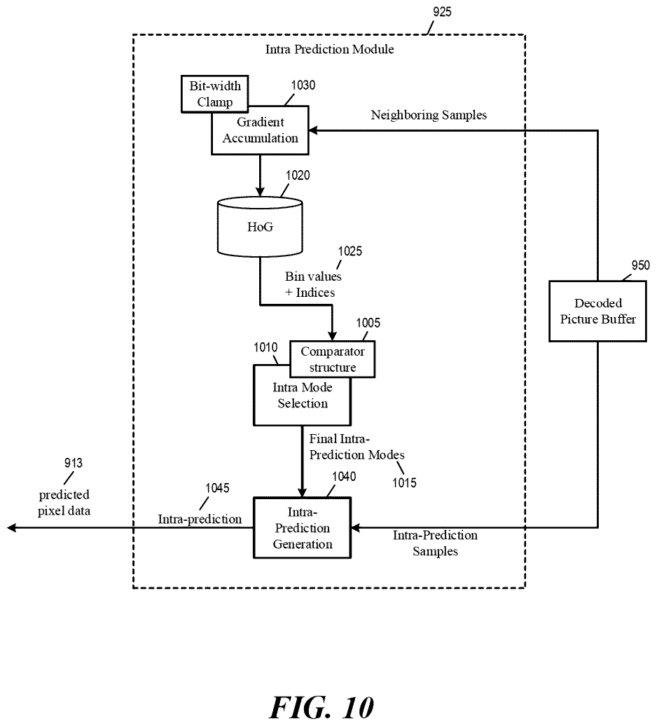

FIG. 9 illustrates an example video decoder 900 that may implement decoder-side intra mode derivation (DIMD). As illustrated, the video decoder 900 is an image-decoding or video-decoding circuit that receives a bitstream 995 and decodes the content of the bitstream into pixel data of video frames for display. The video decoder 900 has several components or modules for decoding the bitstream 995, including some components selected from an inverse quantization module 911, an inverse transform module 910, an intra-prediction module 925, a motion compensation module 930, an in-loop filter 945, a decoded picture buffer 950, a MV buffer 965, a MV prediction module 975, and a parser 990. The motion compensation module 930 is part of an inter-prediction module 940.

In some embodiments, the modules 910-990 are modules of software instructions being executed by one or more processing units (e.g., a processor) of a computing device. In some embodiments, the modules 910-990 are modules of hardware circuits implemented by one or more ICs of an electronic apparatus. Though the modules 910-990 are illustrated as being separate modules, some of the modules can be combined into a single module.

The parser 990 (or entropy decoder) receives the bitstream 995 and performs initial parsing according to the syntax defined by a video-coding or image-coding standard. The parsed syntax element includes various header elements, flags, as well as quantized data (or quantized coefficients) 912. The parser 990 parses out the various syntax elements by using entropy-coding techniques such as context-adaptive binary arithmetic coding (CABAC) or Huffman encoding.

The inverse quantization module 911 de-quantizes the quantized data (or quantized coefficients) 912 to obtain transform coefficients, and the inverse transform module 910 performs inverse transform on the transform coefficients 916 to produce reconstructed residual signal 919. The reconstructed residual signal 919 is added with predicted pixel data 913 from the intra-prediction module 925 or the motion compensation module 930 to produce decoded pixel data 917. The decoded pixels data are filtered by the in-loop filter 945 and stored in the decoded picture buffer 950. In some embodiments, the decoded picture buffer 950 is a storage external to the video decoder 900. In some embodiments, the decoded picture buffer 950 is a storage internal to the video decoder 900.

The intra-prediction module 925 receives intra-prediction data from bitstream 995 and according to which, produces the predicted pixel data 913 from the decoded pixel data 917 stored in the decoded picture buffer 950. In some embodiments, the decoded pixel data 917 is also stored in a line buffer (not illustrated) for intra-picture prediction and spatial MV prediction.

In some embodiments, the content of the decoded picture buffer 950 is used for display. A display device 955 either retrieves the content of the decoded picture buffer 950 for display directly, or retrieves the content of the decoded picture buffer to a display buffer. In some embodiments, the display device receives pixel values from the decoded picture buffer 950 through a pixel transport.

The motion compensation module 930 produces predicted pixel data 913 from the decoded pixel data 917 stored in the decoded picture buffer 950 according to motion compensation MVs (MC MVs). These motion compensation MVs are decoded by adding the residual motion data received from the bitstream 995 with predicted MVs received from the MV prediction module 975.

The MV prediction module 975 generates the predicted MVs based on reference MVs that were generated for decoding previous video frames, e.g., the motion compensation MVs that were used to perform motion compensation. The MV prediction module 975 retrieves the reference MVs of previous video frames from the MV buffer 965. The video decoder 900 stores the motion compensation MVs generated for decoding the current video frame in the MV buffer 965 as reference MVs for producing predicted MVs.

The in-loop filter 945 performs filtering or smoothing operations on the decoded pixel data 917 to reduce the artifacts of coding, particularly at boundaries of pixel blocks. In some embodiments, the filtering or smoothing operations performed by the in-loop filter 945 include deblock filter (DBF), sample adaptive offset (SAO), and/or adaptive loop filter (ALF).

FIG. 10 illustrates portions of the video decoder 900 that implement DIMD based on reduced bit-widths. Specifically, the figure illustrates the components of the intra-prediction module 925 of the video decoder 900. As illustrated, the intra-prediction module 925 includes a gradient accumulation module 1030, a HoG storage 1020, an intra mode selection module 1010, and an intra-prediction generation module 1040. The intra-prediction module 925 may use these modules to perform DIMD intra-prediction for both luma and chroma components.

The gradient accumulation module 1030 receives neighboring samples of the current block from the decoded picture buffer 950 and computes gradient amplitudes for different intra mode directions. The accumulated gradient amplitude of each HoG bin is limited (e.g., clamped) to a maximum allowed value 2^{W}−1 based on a predetermined bit-width W. The (clamped) accumulated gradient amplitudes are stored in the HoG storage 1020 as values in different bins that correspond to the different intra mode directions.

The intra mode selection module 1010 examines the different bins stored in the HoG storage 1020 to identify the two (or more) final DIMD intra modes 1015. The intra mode selection module 1010 includes a comparator tree 1005 that compares bin data items 1025 from different HoG bins to identify the two or more bins having the highest accumulated gradient amplitudes. In some embodiments, each bin data item includes the bin value at the MSB and the bin index at the LSB. In some of these embodiments, the bin index in each data item is bit-wise inverted.

In some embodiments, the comparator structure 1005 includes one comparator trees that is used to identify the two (or more) bins with the highest accumulated bin values from all HoG bins. The comparator tree is a cascaded structure of N-in-M-out comparator elements (e.g., I3M2 elements) (e.g., cascaded structure 510).

In some embodiments, the comparator structure 1005 includes two (or more) comparator trees that are used to identify the two (or more) bins with the highest accumulated bin values. Each comparator tree is used to identify one bin from a different subset (e.g., odd vs. even) of the HoG bins. Each of the two or more comparator trees is a cascaded structure constructed from 2-in-1-out comparator elements (CMPs) (e.g., comparator trees 410 and 420).

The intra-prediction generation module 1040 uses the final intra prediction mode(s) 1015 to generate an intra-prediction 1045 for the current block. The final prediction mode(s) 1015 may include two or more DIMD intra modes, and the intra-prediction generation module 1040 may fetch multiple predictions/predictors from the decoded picture buffer 950 based on the multiple DIMD intra modes. The fetched multiple predictors are blended to generate the intra-prediction 1045 to be used as the predicted pixel data 913.

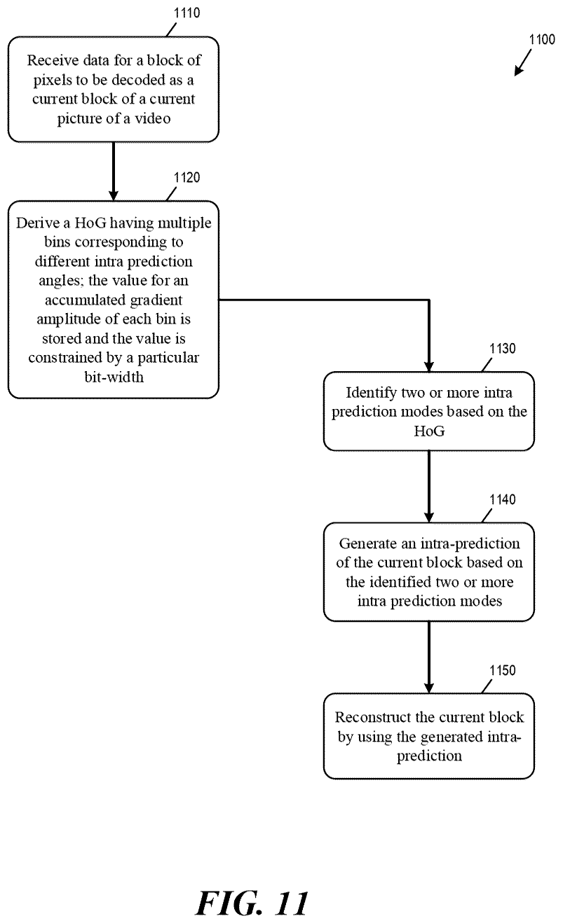

FIG. 11 conceptually illustrates a process 1100 that performs DIMD with reduced bit-widths. In some embodiments, one or more processing units (e.g., a processor) of a computing device implementing the decoder 900 performs the process 1100 by executing instructions stored in a computer readable medium. In some embodiments, an electronic apparatus implementing the decoder 900 performs the process 1100.

The decoder receives (at block 1110) data to be decoded as a current block of pixels in a current picture in a video.

The decoder derives (at block 1120) a histogram of gradients (HoG) having a plurality of bins that correspond to different intra prediction angles. A value for an accumulated gradient amplitude of each bin is stored and the value is constrained by a particular bit-width. In some embodiments, the stored accumulated gradient amplitude is clamped to be less than a particular value based on the particular bit-width. In some embodiments, the particular bit-width is 18 bits. In some embodiments, the particular bit-width can be 12, 13, 14, 15, 16, 17, 18, 19, or 20 bits.

The decoder identifies (at block 1130) two or more intra prediction modes based on the HoG. In some embodiments, the two or more intra prediction modes are identified from the plurality of bins of the HoG by a comparator structure having one or more N-in-M-out comparator elements. Each N-in-M-out element selects M largest values from N values, M and N are integers, N>M≥2. Each input to the N-in-M-out comparator element includes the value stored in a bin of the HoG and an index assigned to the bin. The index is appended to the value as the least significant part of the input, and the index may be bit-wise inverted. In some embodiments, at least an input or at least an output of the N-in-M-out comparator element is constrained by the particular bit-width.

In some embodiments, the two or more intra prediction modes are identified from the plurality of bins of the HoG by two or more comparison trees, each of the comparison tree identifying a different intra prediction mode. A first comparison tree identifies a first intra prediction mode from HoG bins with odd-numbered indices and a second comparison trees identifies a second intra prediction mode from HoG bins with even-numbered indices.

The decoder generates (at block 1140) an intra-prediction of the current block based on the identified two or more intra prediction modes. The decoder reconstructs (at block 1150) the current block by using the generated intra-prediction. The decoder may then provide the reconstructed current block for display as part of the reconstructed current picture.

### VI. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

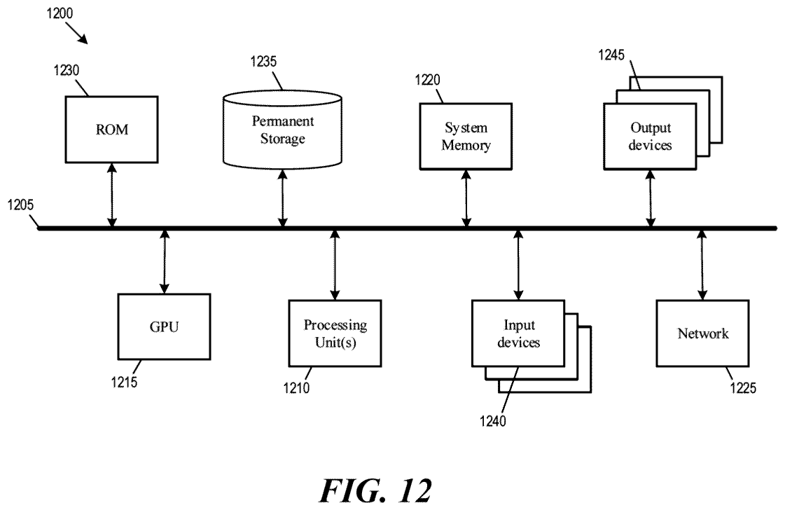

FIG. 12 conceptually illustrates an electronic system 1200 with which some embodiments of the present disclosure are implemented. The electronic system 1200 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1200 includes a bus 1205, processing unit(s) 1210, a graphics-processing unit (GPU) 1215, a system memory 1220, a network 1225, a read-only memory 1230, a permanent storage device 1235, input devices 1240, and output devices 1245.

The bus 1205 collectively represents all system, peripheral, and chipset buses that communicatively connect the numerous internal devices of the electronic system 1200. For instance, the bus 1205 communicatively connects the processing unit(s) 1210 with the GPU 1215, the read-only memory 1230, the system memory 1220, and the permanent storage device 1235.

From these various memory units, the processing unit(s) 1210 retrieves instructions to execute and data to process in order to execute the processes of the present disclosure. The processing unit(s) may be a single processor or a multi-core processor in different embodiments. Some instructions are passed to and executed by the GPU 1215. The GPU 1215 can offload various computations or complement the image processing provided by the processing unit(s) 1210.

The read-only-memory (ROM) 1230 stores static data and instructions that are used by the processing unit(s) 1210 and other modules of the electronic system. The permanent storage device 1235, on the other hand, is a read-and-write memory device. This device is a non-volatile memory unit that stores instructions and data even when the electronic system 1200 is off. Some embodiments of the present disclosure use a mass-storage device (such as a magnetic or optical disk and its corresponding disk drive) as the permanent storage device 1235.

Other embodiments use a removable storage device (such as a floppy disk, flash memory device, etc., and its corresponding disk drive) as the permanent storage device. Like the permanent storage device 1235, the system memory 1220 is a read-and-write memory device. However, unlike storage device 1235, the system memory 1220 is a volatile read-and-write memory, such a random access memory. The system memory 1220 stores some of the instructions and data that the processor uses at runtime. In some embodiments, processes in accordance with the present disclosure are stored in the system memory 1220, the permanent storage device 1235, and/or the read-only memory 1230. For example, the various memory units include instructions for processing multimedia clips in accordance with some embodiments. From these various memory units, the processing unit(s) 1210 retrieves instructions to execute and data to process in order to execute the processes of some embodiments.

The bus 1205 also connects to the input and output devices 1240 and 1245. The input devices 1240 enable the user to communicate information and select commands to the electronic system. The input devices 1240 include alphanumeric keyboards and pointing devices (also called “cursor control devices”), cameras (e.g., webcams), microphones or similar devices for receiving voice commands, etc. The output devices 1245 display images generated by the electronic system or otherwise output data. The output devices 1245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 12, bus 1205 also couples electronic system 1200 to a network 1225 through a network adapter (not shown). In this manner, the computer can be a part of a network of computers (such as a local area network (“LAN”), a wide area network (“WAN”), or an Intranet, or a network of networks, such as the Internet. Any or all components of electronic system 1200 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 8 and FIG. 11) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data for a block of pixels to be encoded or decoded as a current block of a current picture of a video;
deriving a histogram of gradients (HoG) comprising a plurality of bins corresponding to different intra prediction angles, wherein a value for an accumulated gradient amplitude of each bin is stored and the value is constrained by a particular bit-width;
identifying two or more intra prediction modes based on the HoG;
generating an intra-prediction of the current block based on the identified two or more intra prediction modes; and
encoding or decoding the current block by using the generated intra-prediction.

2. The video coding method of claim 1, wherein the particular bit-width is 18 bits.

3. The video coding method of claim 1, wherein the particular bit-width is one of 12, 13, 14, 15, 16, 17, 18, 19, and 20 bits.

4. The video coding method of claim 1, wherein the stored accumulated gradient amplitude is clamped to be less than a particular value based on the particular bit-width.

5. The video coding method of claim 1, wherein the two or more intra prediction modes are identified from the plurality of bins of the HoG by a comparator structure comprising one or more N-in-M-out comparator elements, wherein each N-in-M-out element selects M largest values from N values, wherein M is an integer greater or equal to two and N is an integer larger than M.

6. The video coding method of claim 5, wherein each input to the N-in-M-out comparator element comprises the value stored in a bin of the HoG and an index assigned to the bin, wherein the index is appended to the value as the least significant part of the input.

7. The video coding method of claim 6, wherein the index is bit-wise inverted.

8. The video coding method of claim 5, wherein at least an input or at least an output of the N-in-M-out comparator element is constrained by the particular bit-width.

9. The video coding method of claim 1, wherein the two or more intra prediction modes are identified from the plurality of bins of the HoG by two or more comparison trees, each of the comparison tree identifying a different intra prediction mode.

10. The video coding method of claim 9, wherein a first comparison tree identifies a first intra prediction mode from HoG bins with odd-numbered indices and a second comparison trees identifies a second intra prediction mode from HoG bins with even-numbered indices.

11. An electronic apparatus comprising:
a video coder circuit configured to perform operations comprising:
receiving data for a block of pixels to be encoded or decoded as a current block of a current picture of a video;
deriving a histogram of gradients (HoG) comprising a plurality of bins corresponding to different intra prediction angles, wherein a value for an accumulated gradient amplitude of each bin is stored and the value is constrained by a particular bit-width;
identifying two or more intra prediction modes based on the HoG;
generating an intra-prediction of the current block based on the identified two or more intra prediction modes; and
encoding or decoding the current block by using the generated intra-prediction.

12. A video decoding method comprising:
receiving data for a block of pixels to be decoded as a current block of a current picture of a video;
deriving a histogram of gradients (HoG) comprising a plurality of bins corresponding to different intra prediction angles, wherein a value for an accumulated gradient amplitude for each bin is stored and the value is constrained by a particular bit-width;
identifying two or more intra prediction modes based on the HoG;
generating an intra-prediction of the current block based on the identified two or more intra prediction modes; and
reconstructing the current block by using the generated intra-prediction.

13. A video encoding method comprising:
receiving data for a block of pixels to be encoded as a current block of a current picture of a video;
deriving a histogram of gradients (HoG) comprising a plurality of bins corresponding to different intra prediction angles, wherein a value for an accumulated gradient amplitude of each bin is stored and the value is constrained by a particular bit-width;
identifying two or more intra prediction modes based on the HoG;
generating an intra-prediction of the current block based on the identified two or more intra prediction modes; and
encoding the current block by using the generated intra-prediction.
